(19) United States
(12) Patent Application Publication
(10) Pub. No.: US 2013/0067265 A1
(43) Pub. Date: Mar. 14, 2013

(54) METHOD AND APPARATUS FOR ALARM FOR AIR FILTER

(71) Applicant: Larry Grayson, Greenville, MS (US)

(72) Inventor: Larry Grayson, Greenville, MS (US)

(21) Appl. No.: 13/286,269

(22) Filed: Nov. 1, 2011

Related U.S. Application Data
(60) Provisional application No. 61/532,597, filed on Sep. 9, 2011.
(60) Provisional application No. 61/536,267, filed on Sep. 19, 2011.

(51) Int. Cl. G06F 1/14; G08B 21/24; G06F 1/24

(52) U.S. Cl. 713/502

(57) ABSTRACT

An apparatus including an air filter for an air conditioning device, a warning device, a computer processor, a computer memory, a count setting device, and a reset device. The computer processor is programmed to set a value of a timer count variable to an operator input start value in the computer memory in response to the count setting device. The computer processor is programmed to count down the value of the timer count variable and when the value of the timer count variable has counted down to an alarm level, to activate the warning device. The reset device is actuated by an operator to cause the computer processor to deactivate the warning device and to reset the value of the timer count variable to the operator input start value, and to cause the value of the timer count variable to be counted down.

### CROSS REFERENCE TO RELATED APPLICATION(S)

This application claims the priority of U.S. provisional patent application Ser. No. 61/532,597, filed on Sep. 9, 2011, titled “A/C Filter Alarm”, inventor and applicant Larry Grayson, and U.S. provisional patent application Ser. No. 61/536,267 filed on Sep. 19, 2011 titled “NC Filter Alarm”, inventor and applicant Larry Grayson.

### FIELD OF THE INVENTION

The present invention relates generally to apparatus and methods for providing alarms to indicate when an air conditioning filter needs to be changed.

### BACKGROUND OF THE INVENTION

The most important maintenance task that will ensure the efficiency of one's air conditioner is to routinely replace or clean its filters. Clogged, dirty filters block normal airflow and reduce a system's efficiency significantly. With normal airflow obstructed, air that bypasses the filter may carry dirt directly into the evaporator coil and impair the coil's heat-absorbing capacity. Filters need to be changed every month or two, especially during the cooling season. Most homeowners never think of this until the unit stops working properly or completely breaks down; “out of sight, out of mind”. This neglect can cost the consumer excess expenditures in repair or replacements bills.

There are various devices known for providing alarms to indicate when an air conditioning filter needs to be changed. U.S. Pat. No. 5,772,732 to James et. al. discloses a circuit for generating a signal to remind someone to replace a filter in an air handler of an air heating or cooling system. (James et. al., col. 4, lns. 25-30). In James et. al. an apparatus 10 may activate a signaling means such as a buzzer BZ1 and a light source in the form of a diode LED to signal an operator to replace a filter 14. (James et. al. col. 30, lns. 19-42). The apparatus may shut down the system 20 if the filter 14 is not replaced. (Id.) A mechanism is disclosed for resetting the mechanism for counting to begin counting out a replacement time period again upon replacement of a filter. (James, et. al. col. 3, lns. 15-25). A switch 2 is a normally closed switch which is held open by the presence of the filter 14; and if the filter is removed reset circuit 60 is reset by normally closed switch 2. (James, col. 29, lns. 45-55). An operator can select and set a primary period which is counted out and the operator is signaled at the end of the primary period to replace the filter. (James, et. al. col. 3, lns. 35-40).

U.S. Pat. No. 6,888,466 to Dermody discloses an air conditioning filter 10 incorporating a timer. (Dermody, col. 2, ln. 27-53). The timer has a start button 22, and a speaker 26. (Id.) The start button 22 can be pressed to activate a timing circuit when the filter 10 is ready to be inserted into an air conditioner. (Id.) At the end of a countdown and audible alarm sounds. (Id.) Dermody discloses a display 250 to show the number of days that the filter has been in operation since the start button 222 was activated or the number of days remaining until alarm will activate. (Dermody, col. 3, lns. 1-6). A group of buttons 254 can be used to change or set the number of days from the time the start button is pressed until the alarm sounds. (Dermody, col. 3, ln. 15-20). A stop button 258 can be provided to silence the alarm or stop feature can be incorporated into start button. (Dermody, col. 3, lns. 29-34). A status indicator light 260 is also provided to indicate the status of the timing circuit. (Dermody, col. 3, lns. 34-44).

### SUMMARY OF THE INVENTION

One or more embodiments of the present invention provide an apparatus comprising an air filter for an air conditioning device, a warning device, a computer processor, a computer memory, a count setting device, and a reset device. The computer processor is programmed to set a value of a timer count variable to an operator input start value in the computer memory in response to the count setting device. The computer processor is programmed to count down the value of the timer count variable and when the value of the timer count variable has counted down to an alarm level, the computer processor is programmed to activate the warning device. The reset device is configured to be actuated by an operator to cause the computer processor to deactivate the warning device and to reset the value of the timer count variable to the operator input start value, and to cause the value of the timer count variable to be counted down.

The warning device may include an audible alarm and/or a visual alarm. The apparatus may further include a computer display device, wherein the computer processor causes the computer display device to display the value of the timer count variable and/or the operator input start value.

In one or more embodiments a method is provided comprised of placing an apparatus in close proximity to air conditioner filter, wherein the apparatus includes a warning device, a computer memory, a count setting device, and a reset device. The method may further include setting a value of a timer count variable to an operator input start value in the computer memory in response to the count setting device; counting down the value of the timer count variable and when the value of the timer count variable has counted down to an alarm level, activating the warning device; and deactivating the warning device and resetting the value of the timer count variable to the operator input start value, and thereafter causing the value of the timer count variable to be counted down in response to activation of the reset device.

It is an object of one or more embodiments of the present invention to introduce an alarm-enhanced filter which reminds the consumer to change the filter. For homeowners stressed by work, busy family schedules, and a depressed economy, using this alarm-enhanced filter reduces worry or stress and, in fact, saves money by lowering the energy consumption for an air conditioner and increasing the life of the unit.

One or more embodiments of the present invention provide a disposable air conditioning (A/C) filter with a built-in alarm which alerts and reminds a user to check on the status of a used filter.

### BRIEF DESCRIPTION OF THE DRAWINGS

FIG. 1 shows a front view of an apparatus in accordance with an embodiment of the present invention;

FIG. 2A shows a front, right side, bottom perspective view of a first portion of the apparatus of FIG. 1;

FIG. 2B shows a front, right side, bottom perspective view of a second portion of the apparatus of FIG. 1;

FIG. 2C shows a front, right side, bottom perspective view of a third portion of the apparatus of FIG. 1;

FIG. 2D shows a front, right side, bottom perspective view of a fourth portion of the apparatus of FIG. 1;

FIG. 2E shows a back, right side, bottom perspective view of the fourth portion of the apparatus of FIG. 1;

FIG. 3 shows a front, left side perspective view of the apparatus of FIG. 1 in a disassembled state;

FIG. 4 shows a rear, left side perspective view of the apparatus of FIG. 1 in a disassembled state;

FIG. 5 shows a top, right side, bottom perspective view of a filter device which includes the apparatus of FIG. 1 fixed to the filter device;

FIG. 6 shows a block diagram of components of the apparatus of FIG. 1;

FIG. 7 shows a side view of an apparatus in accordance with another embodiment of the present invention mounted to a first structure;

FIG. 8A shows a rear view of an apparatus in accordance with another embodiment of the present invention; and

FIG. 8B shows a side view of the apparatus of FIG. 8A attached to a second structure.

### DETAILED DESCRIPTION OF THE DRAWINGS

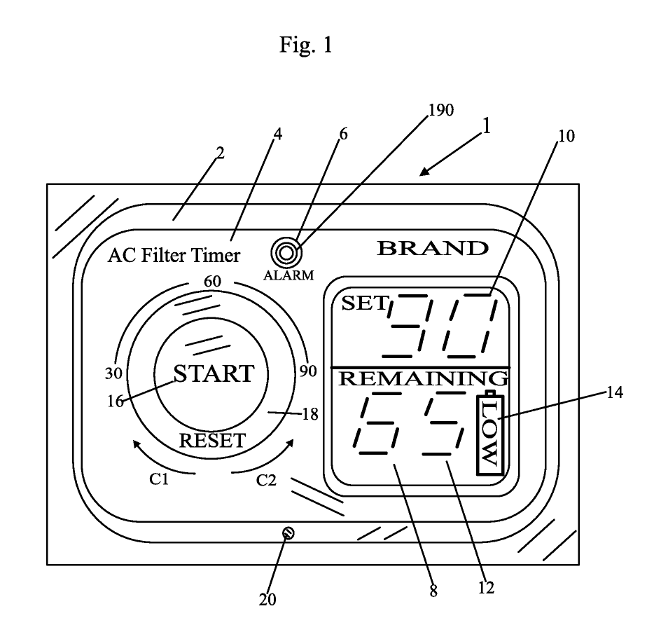

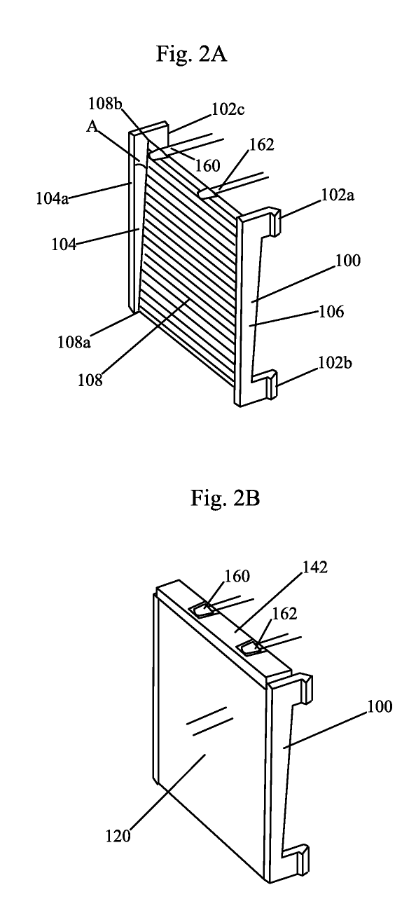

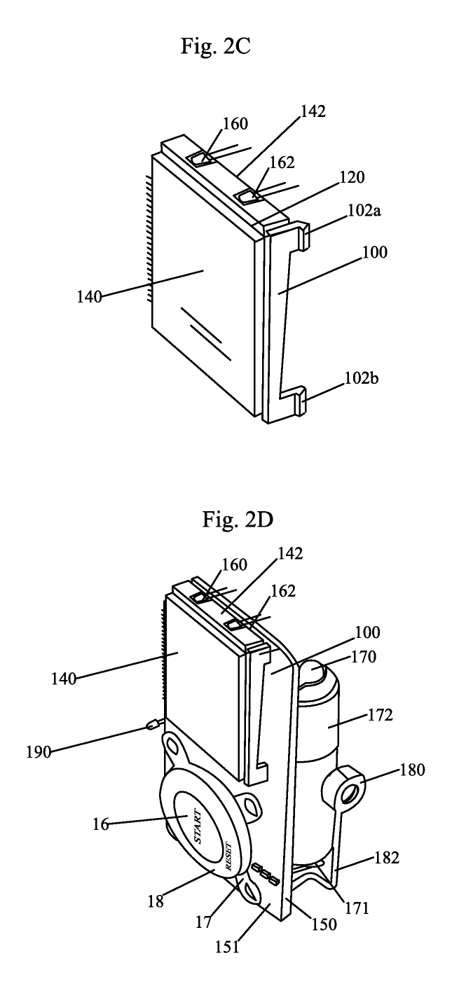

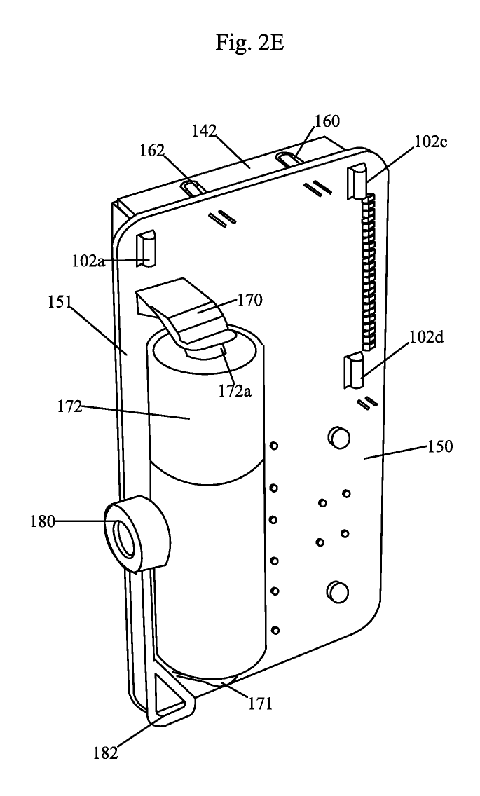

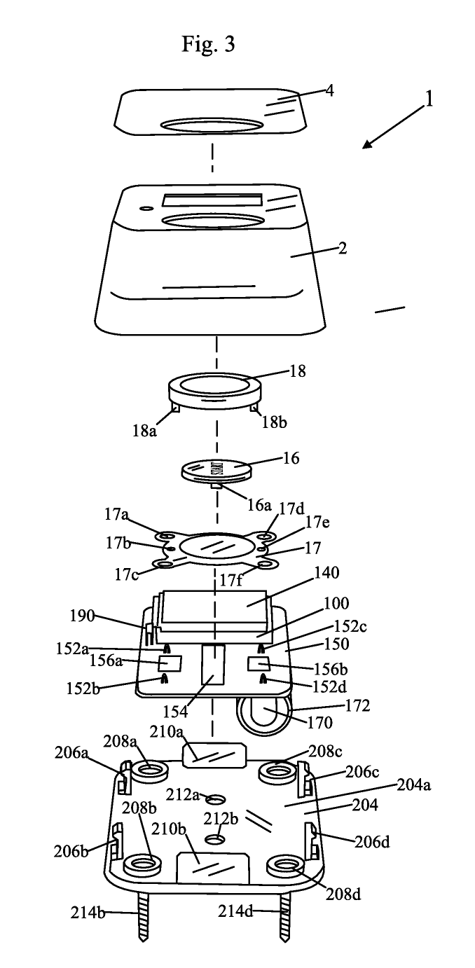

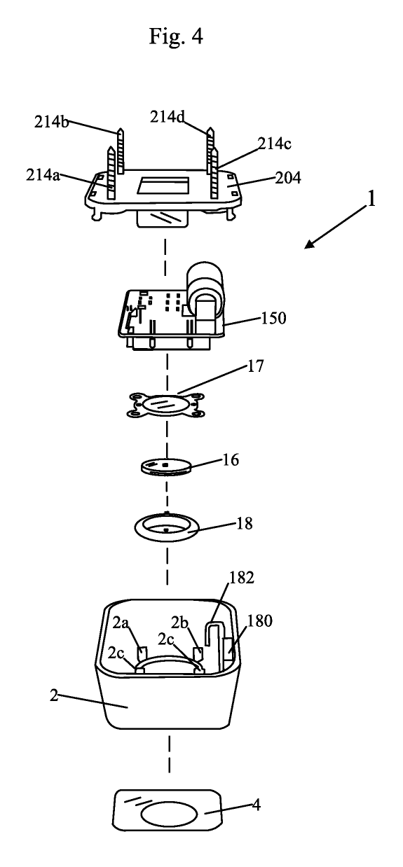

FIG. 1 shows a front view of an apparatus 1 in accordance with an embodiment of the present invention. FIG. 2A shows a front, right side, bottom perspective view of a first portion of the apparatus 1 of FIG. 1. FIG. 2B shows a front, right side, bottom perspective view of a second portion of the apparatus 1 of FIG. 1. FIG. 2C shows a front, right side, bottom perspective view of a third portion of the apparatus 1 of FIG. 1. FIG. 2D shows a front, right side, bottom perspective view of a fourth portion of the apparatus 1 of FIG. 1. FIG. 2E shows a back, right side, bottom perspective view of the fourth portion of the apparatus 1 of FIG. 1. FIG. 3 shows a front, left side perspective view of the apparatus 1 of FIG. 1 in a disassembled state. FIG. 4 shows a rear, left side perspective view of the apparatus 1 of FIG. 1 in a disassembled state.

Referring to FIGS. 3 and 4 the apparatus 1 includes a bracket or wall bracket 204, a device or portion 150, a keys or switches support 17, a start key or button 16, a reset key or button 18, a front cabinet or front housing 2, and a front lens or front cover 4.

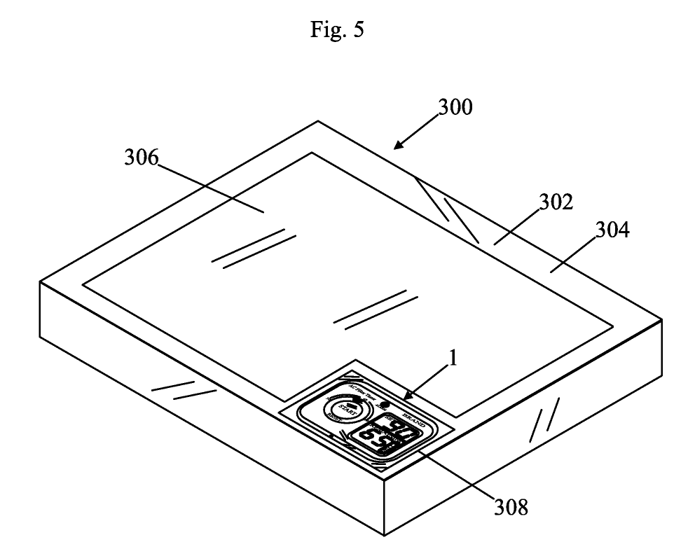

The bracket 204 includes openings 208a, 208b, 208c, and 208d. The openings 208a-d may be circular. The openings 208a-d may have a diameter which allows passage of a screw portion of screws 214a, 214b, 214c, and 214d, respectively, but does not allow passage of a head or cap portion of the screws 214a-d, respectively. The screws 214a-d can be used to mount or fix the apparatus 1 onto or into a filter 302, shown in FIG. 5 to form a device 300 which includes the filter 302 and the apparatus 1. The screws 214a-d can be screwed into an internal part of a frame 304 of the filter 302. An opening 308 can be cut into the frame 304 to insert the apparatus 1 into the frame 304, so that only the front face of the apparatus 1 is showing as shown in FIG. 5.

The bracket 204 further includes attachment devices 206a, 206b, 206c, and 206d which may be snap connection or attachment devices for attaching front housing 2 to the bracket 204. The bracket 204 may further include flanges or walls 210a and 210b which are used to space the device 150 apart from the bracket inner surface 204a so that the device 150 can be properly held between the bracket 204 and the front housing 2. The bracket 204 may include openings 212a and 212b.

The device or portion 150 and parts of the device 150 will now be described with reference to FIGS. 2A-2E. The device or portion 150 includes a display support 100 and light emitting diodes (LEDS) 160 and 162, shown in FIG. 2A. The display support 100 include support members 104 and 106 and a support panel 108 which is connected to the support members 104 and 106, and in between the support members 104 and 106. The support panel 108 is at an angle A with respect to a front surface 104a of the member 104, so that the support panel 108 is slanted with respect to members 104 and 108. This slanting allows light from the LEDs 160 and 162 to be distributed evenly over the support panel 108 after other components shown in FIGS. 2B-2E are attached to make up the device 150. The members 104 and 106 include protrusions or attachment devices, such as snap connection attachment devices 102a and 102b shown in FIGS. 2A and 102c and 102d shown in FIG. 2E. The attachment devices 102a-d allow the display support 100 to be attached to a circuit board 151 shown in FIG. 2D and FIG. 2E.

FIG. 2B shows a display lens 120 and computer processor and computer memory circuit 142 which have been attached to the display support 100.

FIG. 2C shows a display device 140 which has been attached to the display lens 120, and display support 100. The display device 140 may be an LCD (liquid crystal display) display device.

FIG. 2D shows the display support 100, display lens 120, display device 140, and computer processor and computer memory circuit 142 attached to the circuit board 151. FIG. 2D also shows the start key or switch 16, the reset key or switch 18, and the key or switches support 17 fixed to the circuit board 151. FIG. 2D also shows a battery or power supply 172 held by terminal connectors 170 and 171 to the circuit board 151. FIG. 2D also shows an audio or buzzer alarm 180 connected by device 182 to the circuit board 151. FIG. 2D also shows a visual alarm 190, which may be a light emitting diode, connected to the circuit board 151.

The device 150 may also include switches 154, 156a, and 156b shown in FIG. 3. When the apparatus 1 is assembled as in FIG. 1 and FIG. 5, the switch 154 can be actuated by a protrusion 16a of the start switch 16 to cause a timer residing in computer memory of the computer processor and computer memory circuit 142 to start counting down. When the apparatus 1 is assembled, the switches 156a and 156b can be actuated by protrusions 18a and 18b respectively shown in FIG. 3, to cause the timer in computer memory of circuit 142 to be reset to a start value. For example the timer could be reset to a certain number of days. When the timer in circuit 142 has counted down to zero, in at least one embodiment, the circuit 142 causes the audio alarm 180 to emit a sound, and also causes the visual alarm 190 to be lit, to emit a certain color light, or to blink on an off. Until the timer has counted down to zero, the alarm 180 would emit no sound, and the visual alarm 190 may emit no light, in at least one embodiment.

The switches support 17 may be made of rubber and may be fixed to the circuit board 151 as shown in FIG. 2D in any manner, such as by glue or by screws. The switches support 17 hold the reset key or switches 18 to the circuit board 151, via protrusions 18a and 18b, through snap openings 17b and 17e respectively, but may allow the reset key 18 to move up and down, after connected to the circuit board 151, to allow depression of the switches 156a and 156b by protrusions 18a and 18b. The start key or switch 16 may be held to the support 17 and the circuit board 151 by the reset key or switch 18 so that the start key 16 can be move up and down to depress the switch 154 with protrusion 16a. The switches support 17 may be connected to the circuit board 151 by fasteners, snap connectors or screws 152a, 152b, 152c, and 152d, which can be inserted through openings 17a, 17c, 17d, and 17f, respectively, as shown by FIG. 3, to properly align the switches support 17, the start button 16, and the reset button 18 with the appropriate switches of 154, 156a, and 156b.

FIG. 1 shows a portion of the front housing 2, the front cover 4, and a visual alarm symbol 6 and the word “ALARM” (which can be printed or otherwise fixed on the front cover 4), indentifying the location of visual LED alarm 190. FIG. 1 also shows the words “AC FILTER TIMER” which can be printed or otherwise fixed on the front cover 4. FIG. 1 also shows the front of the “START” (which can be printed or otherwise fixed to 16) switch 16, and the front of the “RESET” (which can be printed or otherwise fixed to 18) switch 18. FIG. 1 also shows the indicia for “30”, “60”, and “90” days which can be printed or otherwise fixed to front cover 4. In at least one embodiment the number of days for the alarm can be set by turning the reset switch 18 in a clockwise C1 direction to set a greater number of days or in the counterclockwise C2 direction to set a lesser number of days. A location 20 shown in FIG. 1, may be the location of the audio or audible alarm 180.

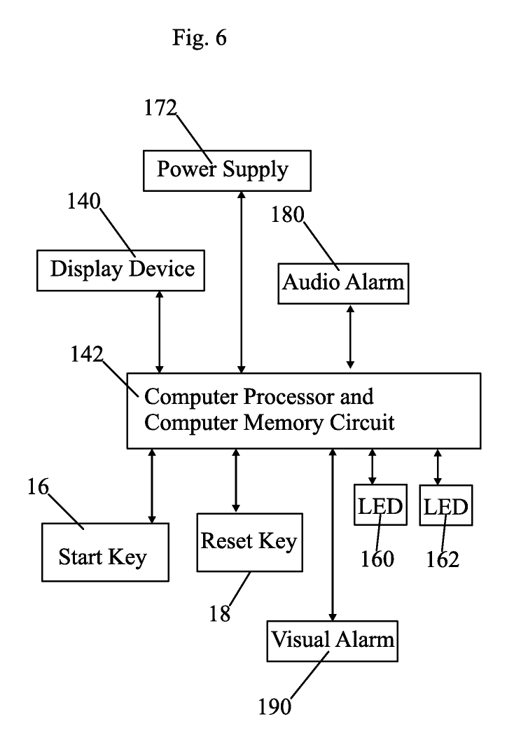

FIG. 1 shows a display area 8 which may include an upper display region 10 and a lower display region 12 of the display device or LCD display 140 of FIG. 2D. The upper display region 10 may display (as caused by the computer processor and computer memory circuit 142 of FIG. 6) the number days set for the alarm to go off such as “90” days in the example shown in FIG. 1. The along word “SET” may be printed or otherwise fixed to the front cover 4 as shown. The lower display region 12 may display (as caused by the computer processor and computer memory circuit 142 of FIG. 6) the number of days remaining for the visual alarm 190 and the audio alarm 180 to go off, such as 65 days in the example of FIG. 1. The word “REMAINING” may be printed or otherwise fixed to the front cover 4 as shown.

The display area 8 may include a low battery indication 14 which can be displayed with the message “LOW”, as shown in FIG. 1, to indicate that the battery 172 is low on power and needs to be charged or replaced. If the battery 172 is not low on power, then the message of “LOW” typically would not be shown in display area 8.

FIG. 6 shows a block diagram of components of the apparatus 1 of FIG. 1. The computer processor and computer memory circuit 142 is in communication with the display device 140, power supply 172, audio alarm 180, start key 16, reset key 18, visual alarm 190 and backlighting LEDS 160 and 162. The components 140, 172, 180, 16, 18, 190, 160 and 162 may only be in communication with a computer processor part of the circuit 142. Communication between circuit 142 and the components 140, 172, 180, 16, 18, 190, 160 and 162 may be by electrical conductors, optical components, wireless communication, or any other type of communication links.

In operation, a person may turn the reset key 18 to set the number of days for the alarms 180 and 190 to be activated. The switches 156a and 156b shown in FIG. 3 may include switch component which react to the turning of the reset key 18 either clockwise or counterclockwise to set the number of days for the alarms 180 and 190 to be activated. The computer processor and computer memory circuit 142 may be programmed by a computer program stored in computer memory to receive signals from the reset key 18 and to store data indicating the number of days for the alarms 180 and 190 to be activated in computer memory of circuit 142. The circuit 142 may also be programmed to cause the display device 140 to display the number of days in display region 10 shown in FIG. 1.

The person or operator, may then press the start switch 16 to cause the time for the activation for the alarms 180 and 190 to count down. The computer processor and computer memory circuit 142 may receive a signal from the start switch 16 and begin to count down a counter stored in computer memory of circuit 142. The circuit 142 may include a clock which is used to count down a counter stored in computer memory of circuit 142. For example, the counter may be set to “90” in computer memory of 142 and then may be decremented or counted down by “1” for every one day that passes in time. The time initially set for the counter may be stored in computer memory of 142, and displayed in display region 10 and the remaining time in the counter may be stored in computer memory of 142 and displayed in display region 12.

When the timing remaining in the counter stored in computer memory reaches “0” days, in this example, the computer processor and computer memory circuit 142 causes the alarms 180 and 190 to be activated. An operator may then push the reset button 18 to reset the time remaining counter to the initial set value, such as in this case “90” days. The computer processor and computer memory circuit 142 is programmed in response to pushing of the reset button 18, to stop the alarms 180 and 190 and to reset a counter remaining to “90” days, in this example. The operator may push the reset switch 18 again, when the counter reaches “0” days, if the operator is satisfied that the air conditioning filter, such as filter 302 in FIG. 5, does not need to be changed.

The present invention in one or more embodiments provides a disposable filter with a built-in alarm which reminds a user to check on the status of an air conditioner. In at least one embodiment, there is a set time schedule by which one or more alarms, such as alarms 180 and 190 activate to warn the user to change the filter.

In at least one embodiment, the visual alarm or LED 190, may emit a red colored light when the counter in computer memory of circuit 142 has reached “0” days; and the LED 190 may emit a green colored light when the time remaining is more than “0” days. The computer processor and computer memory circuit 142 may cause the LED 190 to switch from red to green, when an operator presses the reset switch 18.

In at least one embodiment, the present invention comprises an air filter, such as 302, a circuit board, such as 151, a battery, such as 172, a built-in timer, such as provided by computer processor and computer memory circuit 142, which triggers an audible alarm, such as 180 that alerts users when to change a dirty filter air conditioning filter. The apparatus 1 may be built into small triangular corner of an existing air conditioning filter.

The circuit board 151, the timer, which may be part of computer processor and computer memory circuit 142, the alarms, such as 180 and 190, and the battery 172 are typically not visible to a user. The visual alarm light of 190 is visible from the outside, as shown by FIG. 1. The built-in timer of circuit 142 can be preset. As the preset time is reached, the preset timer triggers the circuit board, which is battery powered, and activates the audio alarm 180 and alarm light 190. Upon noticing the audio alarm 180 and alarm light 190, the user is alerted to check on the status of the filter and/or change the filter, such as 302 if needed. After checking the status of the filter, the user then resets the timer, such as by pressing the reset switch 18 to the intended scheduled time for the next status check.

FIG. 4 shows the audio alarm or buzzer 180 and the 182 inside of the front housing 2, while FIG. 2E shows components 180 and 182 connected to or adjacent circuit board 151. The components 180 and 182, when the entire apparatus 1 is assembled, may be both located with respect to circuit board 151 as shown in FIG. 2E and located with respect to front housing 2 as shown in FIG. 4. In some embodiments the components 180 and 182 may be initially connected to circuit board 151 and then attached to front housing 2, while in other embodiments, the components 180 and 182 may be initially connected to front housing 2 and then circuit board 151 and attached components of device or portion 150 shown in FIGS. 4 and 5 may be connected to front housing 2.

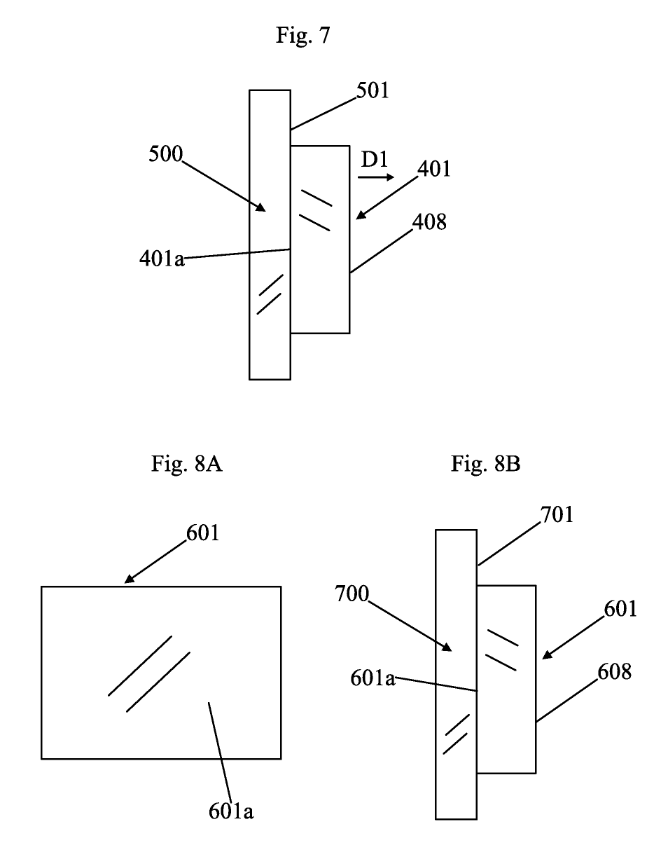

FIG. 7 shows a side view of an apparatus 401 in accordance with another embodiment of the present invention mounted to a first structure 500. The first structure 500 may be a wall, a door, or any other structure. The first structure 500 may be separate from an air filter. The apparatus 401 may be identical to the apparatus 1 described, with reference to FIGS. 1-4 and FIG. 6. The apparatus 401 may be mounted to the structure 500 so that a rear surface 401a of the apparatus 401 is facing, abuts, and lies adjacent to a front surface 501 of the structure 500. The apparatus 401 may have a display area 408 which may be the same as the display area 8 and which faces outwards in the direction D1 so that it can be seen by an operator. The apparatus 401 may be connected to the first structure 500 by fasteners, such as screws, by glue, or in any other manner. The first structure 500 may be a garage wall, a wall on which a thermostat is located, a door, or some other wall or structure.

FIG. 8A shows a rear view of an apparatus 601 in accordance with another embodiment of the present invention. The apparatus 601 may be identical to the apparatus 1 described with reference to FIGS. 1-4 and FIG. 6, except for some optional differences, which will be discussed. The apparatus 601 may include a rear surface 601a which may be made of a magnetic material to allow the apparatus 601 to be attached to a metallic surface such as the metallic surface of a refrigerator. FIG. 8B shows a side view of the apparatus 601 of FIG. 8A attached to a second structure 700. The surface 601a of the apparatus 601, which may be made of a magnetic material, may be attached and attracted to a metallic surface of the surface 701. The second structure 700 may be a refrigerator. The apparatus 601 may include a display area 608 which may be identical to the display area 8 and which is opposite the rear surface 601a.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
an air filter for an air conditioning device;
a warning device;
a computer processor;
a computer memory;
a count setting device;
and a reset device;
wherein the computer processor is programmed to set a value of a timer count variable to an operator input start value in the computer memory in response to the count setting device;
wherein the computer processor is programmed to count down the value of the timer count variable and when the value of the timer count variable has counted down to an alarm level, the computer processor is programmed to activate the warning device;
and wherein the reset device is configured to be actuated by an operator to cause the computer processor to deactivate the warning device and to reset the value of the timer count variable to the operator input start value, and to cause the value of the timer count variable to be counted down.

2. The apparatus of claim 1 wherein
the warning device includes an audible alarm.

3. The apparatus of claim 1 wherein
the warning device includes a visual alarm.

4. The apparatus of claim 2 wherein
the warning device includes a visual alarm.

5. The apparatus of claim 1 further comprising
a computer display device;
and wherein the computer processor causes the computer display device to display the value of the timer count variable.

6. The apparatus of claim 1 further comprising
a computer display device;
and wherein the computer processor causes the computer display device to display the operator input start value.

7. The apparatus of claim 5 further comprising
a computer display device;
and wherein the computer processor causes the computer display device to display the operator input start value.

8. A method comprising:
placing an apparatus in close proximity to air conditioner filter;
wherein the apparatus includes a warning device; a computer memory;
a count setting device; and a reset device;
and further comprising setting a value of a timer count variable to an operator input start value in the computer memory in response to the count setting device;
counting down the value of the timer count variable and when the value of the timer count variable has counted down to an alarm level, activating the warning device; and
deactivating the warning device and resetting the value of the timer count variable to the operator input start value, and thereafter causing the value of the timer count variable to be counted down in response to activation of the reset device.

9. The method of claim 8 wherein
the warning device includes an audible alarm.

10. The method of claim 8 wherein
the warning device includes a visual alarm.

11. The method of claim 9 wherein
the warning device includes a visual alarm.

12. The method claim 8 further comprising
causing a computer display device to display the value of the timer count variable.

13. The method of claim 8 further comprising
causing a computer display device to display the operator input start value.

14. The method of claim 13 further comprising
causing the computer display device to display the operator input start value.
